(19) United States
(12) Patent Application Publication
(10) Pub. No.: US 2026/0126983 A1
(43) Pub. Date: May 7, 2026

(54) DEVICE UPGRADE METHOD AND DEVICE UPGRADE SYSTEM

(71) Applicant: Wistron Corp., New Taipei City (TW)

(72) Inventors: Jiasheng CHEN, New Taipei City (TW); Junxin QIU, New Taipei City (TW); Yongqiang LI, New Taipei City (TW); Qiyuan SU, New Taipei City (TW)

(21) Appl. No.: 19/009,032

(22) Filed: Jan. 3, 2025

(30) Foreign Application Priority Data
Nov. 1, 2024 (CN) 202411555710.0

(51) Int. Cl. G06F 8/65

(52) U.S. Cl. CPC G06F 8/65

(57) ABSTRACT

A device upgrade method includes the following steps. A control module of a display device and an information technology management module of a remote server are used to establish a network connection through the switch module of the display device. The control module is used to transmit device information to the information technology management module. The information technology management module is used to perform a verification process on the device information and generate device upgrade information to the control module. The control module downloads the device upgrade data from the information technology management module according to the device upgrade information, verifies the device upgrade data, and performs an upgrade process on a function device of the display device according to the device upgrade data.

### CROSS REFERENCE TO RELATED APPLICATIONS

This application claims priority of China Patent Application No. 202411555710.0, filed on Nov. 1, 2024, the entirety of which is incorporated by reference herein.

### BACKGROUND OF THE INVENTION

### Field of the Invention

An embodiment of the present invention relates to an upgrade method and an upgrade system, and in particular it relates to a device upgrade method and a device upgrade system.

### Description of the Related Art

Generally, software and hardware are generally highly integrated, interrelated, and coordinated by multiple modules because display devices have various functions. In addition to the main display function, other configuration devices are independent software, hardware and systems, such as the electronic control unit (ECU). How to uniformly upgrade products on the market, maintain each device, provide new functions, provide optimization, and perform related services has become a major issue. If this problem is not solved, it will incur high costs in terms of time, labor, and capital, and affect the user's experience of using the product. Maintaining and upgrading these devices is difficult, especially when devices with large-scale defects appear on the market.

Currently, a display device can be upgraded using a software client download in an operation mode. Manual upgrades of the display devices are also a common method used in the industry. The user needs to log in to the product's official website, search for the corresponding device model, find the required upgrade option content, download the client upgrade package software, turn on and connect the display device, and click to run the software to perform the upgrade. The entire upgrade process requires the user to spend a lot of time to complete these complex and cumbersome operations, and this process is required for each upgrade, seriously affecting the user experience. Upgrading each device is a very large project that incurs high usage costs on users and may lead to user complaints and returns, especially for companies that purchase display devices on a large scale, with hundreds or thousands of devices. The risk may cause huge loss of profits for the brand and its products. Therefore, how to effectively increase device upgrade efficiency has become one of the important problems to be solved.

### BRIEF SUMMARY OF THE INVENTION

An embodiment of the present invention provides a device upgrade method and a device upgrade system, thereby effectively increasing the efficiency of device upgrade, decreasing the time cost and complexity of device upgrade, improving the user experience, improving the process of the device upgrade and maintenance and increasing the convenience of use.

An embodiment of the present invention provides a device upgrade method, which includes the following steps. A control module of a display device and an information technology management module of a remote server are used to establish a network connection through the switch module of the display device. The control module is used to transmit device information to the information technology management module. The information technology management module is used to perform a verification process on the device information and generate device upgrade information to the control module. The control module is used to download the device upgrade data from the information technology management module according to the device upgrade information, to verify the device upgrade data, and to perform an upgrade process on a function device of the display device according to the device upgrade data.

An embodiment of the present invention provides a device upgrade system, which includes a remote server and a display device. The remote server includes an information technology management module. The display device includes a function device, a switch module and a control module. The switch module is connected to the information technology management module. The control module is connected to the switch module and the function device. The control module and the information technology management module are configured to establish a network connection through the switch module. The control module is configured to transmit device information to the information technology management module. The information technology management module is configured to perform a verification process on the device information and generate device upgrade information to the control module. The control module is configured to download the device upgrade data from the information technology management module according to the device upgrade information, to verify the device upgrade data, and to perform an upgrade process on a function device of the display device according to the device upgrade data.

According to the device upgrade method and the device upgrade system disclosed by the embodiment of the present invention, the control module of the display device and the information technology management module of the remote server establish the network connection through the switch module of the display device. The control module transmits device information to the information technology management module. The information technology management module performs the verification process on the device information and generates the device upgrade information to the control module. The control module downloads the device upgrade data from the information technology management module according to the device upgrade information, verifies the device upgrade data, and performs the upgrade process on the function device of the display device according to the device upgrade data. Therefore, it may effectively increase the efficiency of device upgrade, decrease the time cost and complexity of device upgrade, improve the user experience, improve the process of the device upgrade and maintenance and increase the convenience of use.

### BRIEF DESCRIPTION OF THE DRAWINGS

The present invention can be more fully understood by reading the subsequent detailed description and examples with references made to the accompanying drawings, wherein:

FIG. 1 is a schematic view of a device upgrade system according to an embodiment of the present invention;

FIG. 2 is a schematic view of a device upgrade system according to another embodiment of the present invention;

FIG. 3 is a flowchart of a device upgrade method according to an embodiment of the present invention;

FIG. 4 is a detailed flowchart of step S302 in FIG. 3;

FIG. 5 is another detailed flowchart of step S302 in FIG. 3;

FIG. 6 is a detailed flowchart of step S306 in FIG. 3; and

FIG. 7 is a detailed flowchart of step S308 in FIG. 3.

### DETAILED DESCRIPTION OF THE INVENTION

The following description is of the contemplated mode of carrying out the present invention. This description is made for the purpose of illustrating the general principles of the present invention and should not be taken in a limiting sense. The scope of the present invention is determined by reference to the appended claims.

The present invention will be described with respect to particular embodiments and with reference to certain drawings, but the present invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim component does not by itself connote any priority, precedence, or order of one claim component over another or the temporal order in which acts of a method are performed, but are used merely as labels to distinguish one claim component having a certain name from another component having the same name (but for use of the ordinal term) to distinguish the claim components.

In each of the following embodiments, the same reference number represents the same or similar element or component.

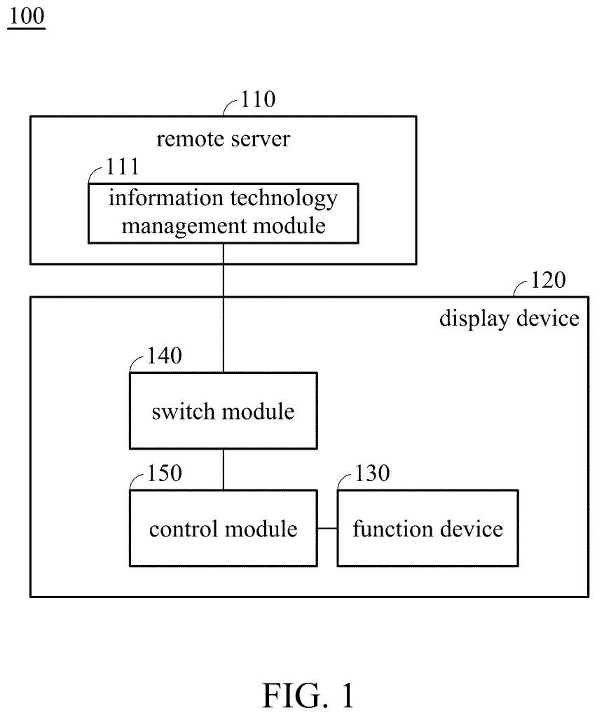

FIG. 1 is a schematic view of a device upgrade system according to an embodiment of the present invention. Please refer to FIG. 1. The device upgrade system 100 may include a remote server 110 and a display device 120. In the embodiment, the display device 120 may be a liquid crystal display (LCD), but the embodiment of the present invention is not limited thereto.

The remote server 110 may include an information technology management (IT management) module 111. In the embodiment, the information technology management module 111 may be used for data communication, management, maintenance between the remote server 110 and the display device 120.

The display device 120 may at least include a function device 130, a switch module 140 and a control module 150. The function device 130 may include at least one electronic control unit (ECU), wherein the electronic control unit may be a webcam, an audio device, an auto brightness controller (ABC) device, etc., but the embodiment of the present invention is not limited thereto.

The switch module 140 may be connected to the information technology management module 110. The control module 150 may be connected to the switch module 140 and the function device 130. In the embodiment, the control module 150 may be a micro control unit (MCU) or another suitable controller, but the embodiment of the present invention is not limited thereto.

In the embodiment, the control module 150 and the information technology management module 111 may establish a network connection through the switch module 140. Then, the control module 150 may transmit device information to the information technology management module 111. Afterward, the information technology management module 111 may perform a verification process on the device information and generate device upgrade information to the control module 150. In an embodiment, after the information technology management module passes the verification process of the device information, the information technology management module may generate the device upgrade information to the control module. Then, the control module 150 may download the device upgrade data from the information technology management module 111 according to the device upgrade information, to verify the device upgrade data, and to perform an upgrade process on the function device 130 according to the device upgrade data.

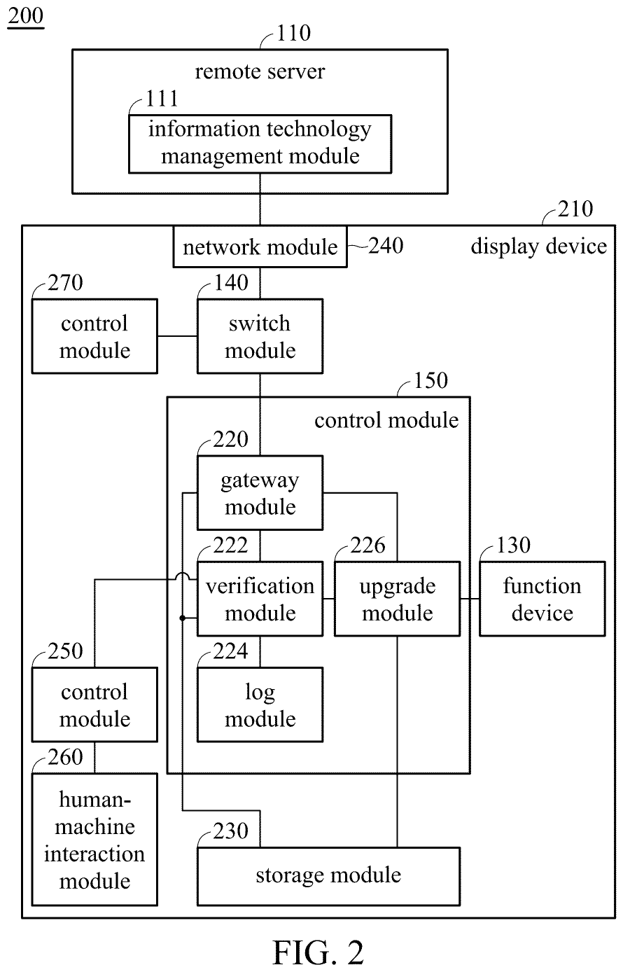

FIG. 2 is a schematic view of a device upgrade system according to another embodiment of the present invention. Please refer to FIG. 2. The device upgrade system 200 may include a remote server 110 and a display device 210. In the embodiment, the display device 210 may be a liquid crystal display, but the embodiment of the present invention is not limited thereto.

The remote server 110 may include an information technology management module 111. In the embodiment, the remote server 110 and the information technology management module 111 in FIG. 2 are the same as or similar to the remote server 110 and the information technology management module 111 in FIG. 1. Accordingly, the remote server 110 and the information technology management module 111 in FIG. 2 may refer to the description of the embodiment of FIG. 1, and the description thereof is not repeated herein.

The display device 210 may at least include a function device 130, a switch device 140, a control module 150, a storage module 230, a network module 240, a control module 250, a human-machine interaction module 260 and a control module 270. In the embodiment, the function device 130, the switch module 140 and the control module 150 in FIG. 2 are the same as or similar to the function device 130, the switch module 140 and the control module 150 in FIG. 1. Accordingly, the function device 130, the switch module 140 and the control module 150 in FIG. 2 may refer to the description of the embodiment of FIG. 1, and the description thereof is not repeated herein.

Furthermore, the control module 150 may include a gateway module 220, a verification module 222, a log module 224 and an upgrade module 226.

The gateway module 220 may be connected to the switch module 140. Furthermore, the gateway module 220 may be connected to the switch module 140 through a reduced media independent interface. The gateway module 220 may establish the network connection with the information technology management module 111 through the switch module 140, transmit device information to the information technology management module 111, and download the device upgrade data from the information technology management module 111 according to the device upgrade information. That is, the gateway module 220 may be used to establish the network connection, obtain the information and data downloads and uploads.

The verification module 222 may be connected to the gateway module 220. The verification module 222 may verify the device upgrade data to generate a device upgrade notification. Furthermore, the verification module 222 may be used to identify and verify the related information of the display device 210, verify whether the device information of the function device 130 is correct, determine whether to upgrade, and determine the data security and device upgrade information.

The log module 224 may be connected to the verification module 222. The log module 224 may record the device upgrade notification. Furthermore, the log module 224 may record and store the related information. For example, if the function device 130 is upgraded successfully, the log module 224 may record the log information such as the new firmware version and the upgrade time point. If the function device 130 fails to upgraded, the log module 224 may the record log information such as a failure log, a failure time point and the related information of the function device 130. If it is a schedule upgrade, the log module 224 may record the log information of the upgrade information of the schedule upgrade. If the user chooses not to upgrade, the log module 224 may record the log information such as a non-upgrade log, a non-upgrade time point and the related information of the function device 130. In addition, the above log information is stored and recorded in the log module 224, and the above log information may also be transmitted to the remote server 110.

The upgrade module 226 may be connected to the gateway module 220, the verification module 222 and the function device 130. Furthermore, the upgrade module 226 may be connected to the function device 130 through an inter-integrated circuit (I2C) or a universal serial bus (USB). The upgrade module 226 may use the device upgrade data to perform the upgrade process on the function device 130 according to the device upgrade notification. Furthermore, the upgrade module 226 may be used to control the upgrade work of the function device 130, and perform the upgrade action on the function device 130 according to the information verification and the user determination result.

The storage module 230 may be connected to the gateway module 220, the verification module 222 and the upgrade module 226 of the control module 150. Furthermore, the storage module 230 may be connected to the gateway module 220, the verification module 222 and the upgrade module 226 of the control module 150 through a serial peripheral interface (SPI). The storage module 230 may store the device upgrade data.

The network module 240 may be connected between the switch module 140 and the information technology management module 111. Furthermore, the network module 240 may be connected to the switch module 140 through a medium dependent interface (MDI). In some embodiments, the network module 240 may be a wired network module, such as a RJ45 connector, but the embodiment of the present invention is not limited thereto. In some embodiments, the network module 240 may be a wireless network module, such as a wireless fidelity (WiFi), but the embodiment of the present invention is not limited thereto.

The control module 250 may be connected to the verification module 222 of the control module 150. Furthermore, the control module 250 may be connected to the verification module 222 of the control module 150 through a universal asynchronous receiver/transmitter (UART). In some embodiments, the control module 250 may be a scaler controller, but the embodiment of the present invention is not limited thereto.

The human-machine interaction module 260 may be connected to the control module 250. The human-machine interaction module 260 may be used to push upgrade-related information to the display screen of the display device 210, so that the user may determine whether to upgrade the function device 130, understand the upgrade progress of the function device 130 and the upgrade-related configuration of the function device 130. In the embodiment, the verification module 222 of the control module 150 may generate upgrade related information to the control module 250 according to the device upgrade information. Then, the control module 250 may transmit the upgrade related information to the human-machine interaction module 260, so that the human-machine interaction module 260 pushes the upgrade related information to the display screen of the display device 210, and the user determines whether to upgrade the function device 130. Afterward, the user may operate the human-machine interaction module 260, so as to generate a corresponding device upgrade instruction. Then, the human-machine interaction module 260 may transmit the device upgrade instruction to the verification module 222 through the control module 250, so as to perform the subsequent upgrade operation.

The control module 270 may be connected to the switch module 140 and a computer device (not shown). In the embodiments, the control module 270 may be a Hub controller, but the embodiment of the present invention is not limited thereto.

In some embodiments, the control module 150 may send a network connection request to the information technology management module 111 through the switch module 140. That is, after the display device 210 is connected to the remote server 110 through the network module 240, the control module 150 (the gateway module 220) may configure information corresponding to the internet protocol (IP) address, the media access control (MAC) address and the related configuration protocol according to the address information of the display device 210 and the address information of the remote server 110 to serve the basis for network addressing and connection, and send the address information to perform the addressing process. Then, the control module 150 (the gateway module 220) may perform the addressing and access process according to the configured internet protocol and media access control addresses of the remote server 110, so as to wait for feedback from the remote server 110.

Afterward, the information technology management module 111 may generate feedback information to the control module 150 (the gateway module 220) according to the network connection request. The control module 150 (the gateway module 220) may establish the network connection according to the feedback information. In addition, after the network connection is established, the control module 150 (the gateway module 220) may set the control module 150 as a connection host and transmit setting information corresponding to the connection host to the information technology management module 111. Then, the information technology management module 111 may set the information technology management module 111 as a connection slave device according to the setting information. And, the information technology management module 111 turns off the active network connection function of the information technology management module 111.

Furthermore, in some embodiments, if the control module 150 (the gateway module 220) does not receive the feedback information of the information technology management module 111, it indicates that the connection between the display device 210 and the remote server 110 fails. At this time, the control module 150 (the gateway module 220) may determine whether the connection number reaches a predetermined connection number (such as 10 times). When determining that the connection number does not reach the predetermined connection number, in response to the connection number not reaching predetermined connection number, the control module 150 (the gateway module 220) may send the network connection request again to try to establish the network connection with the remote server 110 until the connection number reaches the predetermined connection number. In addition, when determining that the connection number is greater than the predetermined connection number, in response to the connection number being greater than the predetermined connection number, the control module 150 (the gateway module 220) stops sending the network connection request until the next connection period or the display device 210 is restarted. Therefore, the power consumption of the display device 210 may be effectively decreased.

In some embodiments, the information technology management module 111 may send the network connection request to the control module 150 through the switch module 140. That is, after the display device 210 is connected to the remote server 110 through the network module 240, the information technology management module 111 may perform the addressing and accesses the display device 210 according to the information such as the internet protocol address and the media access control (MAC) address of the display device 210, so as to wait for feedback from the display device 210. Then, the control module 150 (the gateway module 220) may generate the feedback information to the information technology management module 111 according to the network connection request. The information technology management module 111 may establish the network connection according to the feedback information.

In some embodiments, the administrator may operate the remote server 110, so that the information technology management module 111 actively performs the above network connection operation. In some embodiments, the information technology management module 111 may perform a firmware version detection according to a predetermined detection target number. Then, the count of the information technology management module 111 reaches predetermined detection target number, the information technology management module 111 may automatically perform the version detection. Afterward, if the information technology management module 111 detects that there is a record that the new firmware version has not been upgraded, the information technology management module 111 may actively perform the above network connection operation.

In addition, after the network connection is established, the information technology management module 111 may set the information technology management module 111 as a connection host and transmit setting information corresponding to the connection host to the control module 150 (the gateway module 220). Then, the control module 150 (the gateway module 220) may set the control module 150 (the gateway module 220) as a connection slave device according to the setting information. And, the control module 150 turns off the active network connection function of the control module 150 (the gateway module 220). Furthermore, in some embodiments, the priority of the information technology management module 111 is higher than the priority of the control module 150 (the gateway module 220). That is, once the information technology management module 111 establish the network connection, sets the information technology management module 111 as the connection host and transmit the setting information corresponding to the connection host to the control module 150 (the gateway module 220), at this time, regardless of whether the control module 150 (the gateway module 220) establishes the network connection, the control module 150 (the gateway module 220) may set the control module 150 (the gateway module 220) as the connection slave device.

Moreover, in some embodiments, if the information technology management module 111 does not receive the feedback information of the control module 150 (the gateway module 220), it indicates that the connection between the display device 210 and the remote server 110 fails. At this time, the information technology management module 111 may determine whether the connection number reaches a predetermined connection number (such as 10 times). When determining that the connection number does not reach the predetermined connection number, in response to the connection number not reaching predetermined connection number, the information technology management module 111 may send the network connection request again to try to establish the network connection with the display device 210 until the connection number reaches the predetermined connection number. In addition, when determining that the connection number is greater than the predetermined connection number, in response to the connection number being greater than the predetermined connection number, the information technology management module 111 stops sending the network connection request until the next connection period or the display device 210 is restarted. Therefore, the power consumption of the display device 210 may be effectively decreased.

In some embodiments, the above device information may include a display device name and a display device serial number corresponding to the display device 210 and a device name, a device serial number, a local address and firmware version information corresponding to the function device 130.

In addition, after the information technology management module 111 receive the above device information, the information technology management module 111 may determine whether the display device name and the display device serial number match a predetermined display device name and a predetermined display device serial number. When determining that the display device name and the display device serial number do not match the predetermined display device name and the predetermined display device serial number, in response to the display device name and the display device serial number not matching the predetermined display device name and the predetermined display device serial number, the information technology management module 111 stops verifying and generates warning information.

When determining that the display device name and the display device serial number match the predetermined display device name and the predetermined display device serial number, in response to the display device name and the display device serial number matching the predetermined display device name and the predetermined display device serial number, the information technology management module 111 may determine whether the device name, the device serial number and the local address match a predetermined device name, a predetermined device serial number and a predetermined local address. When determining that the device name, the device serial number and the local address do not match the predetermined device name, the predetermined device serial number and the predetermined local address, in response to the device name, the device serial number and the local address not matching the predetermined device name, the predetermined device serial number and the predetermined local address, the information technology management module 111 stops verifying and generates the warning information.

When determining that the device name, the device serial number and the local address match the predetermined device name, the predetermined device serial number and the predetermined local address, in response to the device name, the device serial number and the local address matching the predetermined device name, the predetermined device serial number and the predetermined local address, the information technology management module 111 may determine whether a firmware version of the firmware version information is the same as a predetermined firmware version.

When determining that the firmware version of the firmware version information is the same as the predetermined firmware version, in response to the firmware version of the firmware version information being the same as the predetermined firmware version, the information technology management module 111 may not generate device upgrade information, it indicates that the function device 130 does not need to be upgraded. When determining that the firmware version is not the same as the predetermined firmware version, in response to the firmware version not being the same as the predetermined firmware version, the information technology management module 111 may generate the device upgrade information to the control module 150, it indicates that the function device 130 needs to be upgraded.

In some embodiments, the control module 150 may determine whether the control module 150 is set as a connection host according to the device upgrade information. 150. When determining that the control module 150 is not set as the connection host, in response to determining that the control module 150 is not set as the connection host, the control module 150 may download the device upgrade data from the information technology management module 111, verify the device upgrade data, and perform the upgrade process on the function device 130 according to the device upgrade data.

That is, when the verification module 222 of the control module 150 determines that the control module 150 is not set as the connection host, the gateway module 220 of the control module 150 may download the device upgrade data from the information technology management module 111 and store the device upgrade data in the storage module 230. Then, the verification module 222 of the control module 150 may read the device upgrade data of the storage module 230 and verify the device upgrade data. Afterward, after verifying that the device upgrade data is correct, the verification module 222 of the control module 150 generates the device upgrade notification to the upgrade module 226. Then, the upgrade module 226 may read the device upgrade data of the storage module 230. And, the upgrade module 226 performs the upgrade process on the function device 130 according to the device upgrade notification and the device upgrade data.

In addition, when determining that the control module 150 is set as the connection host, in response to the control module 150 is set as the connection host, the control module 150 may determine whether the control module 150 receives a device upgrade instruction. When determining that the control module 150 does not receive the device upgrade instruction, the control module 150 does not perform the upgrade process.

When determining that the control module 150 receives the device upgrade instruction, in response to determining that the control module 150 receives the device upgrade instruction, the control module 150 may download the device upgrade data from the information technology management module 111, verify the device upgrade data, and perform the upgrade process on the function device 130 according to the device upgrade data.

That is, when the verification module 222 of the control module 150 determines that the control module 150 is set as the connection host, the verification module 222 of the control module 150 may generate the upgrade related information to the control module 250 according to the device upgrade information. Then, the control module 250 may transmit the upgrade related information to the human-machine interaction module 260, so that the human-machine interaction module 260 pushes the upgrade related information to the display screen of the display device 210, and the user determines whether to upgrade the function device 130. Afterward, the user may operate the human-machine interaction module 260, so as to generate a corresponding device upgrade instruction. Then, the human-machine interaction module 260 may transmit the device upgrade instruction to the verification module 222 through the control module 250. Afterward, the verification module 222 notifies the gateway module 220 of the control module 150 according to the device upgrade instruction, so that the gateway module 220 may download the device upgrade data from the information technology management module 111 and store the device upgrade data in the storage module 230. Then, the verification module 222 may read the device upgrade data of the storage module 230 and verify the device upgrade data. Afterward, after verifying that the device upgrade data is correct, the verification module 222 of the control module 150 generates the device upgrade notification to the upgrade module 226 according to the device upgrade instruction. Then, the upgrade module 226 may read the device upgrade data of the storage module 230. And the upgrade module 226 performs the upgrade process on the function device 130 according to the device upgrade notification, the device upgrade instruction and the device upgrade data.

In the embodiment, the above device upgrade instruction is an immediate upgrade instruction, a scheduled upgrade instruction or a non-upgrade instruction. When the device upgrade instruction is the immediate upgrade instruction, the verification module 222 may immediately generate the device upgrade notification to the upgrade module 226 after verifying that the device upgrade data is correct, so that the upgrade module 226 may immediately perform upgrade processing on the functional device 130 according to the upgrade data and. When the device upgrade instruction is the scheduled upgrade instruction, verification module 222 may set a time timer according to the scheduled upgrade instruction after verifying that the device upgrade data is correct. After the time timer counts to the time point of the scheduled upgrade instruction, the verification module 222 may generate the device upgrade notification to the upgrade module 226, so that the upgrade module 226 may immediately upgrade the functional device 130 according to the device upgrade data. When the device upgrade instruction is the non-upgrade instruction, the verification module 222 may not generate device upgrade notification to the upgrade module 226.

In some embodiments, the information technology management module 111 may encrypt the device upgrade data through a digital signature, and the verification module 222 may decrypt and verify the device upgrade data through the digital signature, so as to ensure the security of the device upgrade data. That is, the information technology management module 111 may first calculate the abstract of the device upgrade data, and then use the private key to encrypt the above abstract to generate the digital signature. Then, when the gateway module 220 downloads the device upgrade data from the information technology management module 111, the information technology management module 111 may send the device upgrade data and the digital signature to the gateway module 220 together. Then, the gateway module 220 stores the device upgrade data and the digital signature in the storage module 230.

Afterward, verification module 222 may read the device upgrade data and the digital signature of the storage module 230. Then, the verification module 222 may first use the same abstract algorithm to calculate the abstract of the above device upgrade data, and then use the pre-obtained public key to decrypt the digital signature. Afterward, the verification module 222 may compare whether the decrypted digital signature and the calculated abstract are consistent. If the decrypted digital signature and the calculated abstract are consistent, it indicates that the device upgrade data has not been tampered with.

In some embodiments, after the display device 210 is connected to the remote server 110 through the network module 240, the control module 150 (the gateway module 220) may register the display device name and the display device serial number corresponding to the display device 210 and the device name, the device serial number, the local address and the firmware version information corresponding to the functional device 130 included in the device information to the information technology management module of the remote server 110, so as to serve as a basis for setting the predetermined display device name, the predetermined display device serial number, the predetermined device name, the predetermined device serial number, the predetermined local address and the predetermined firmware version information.

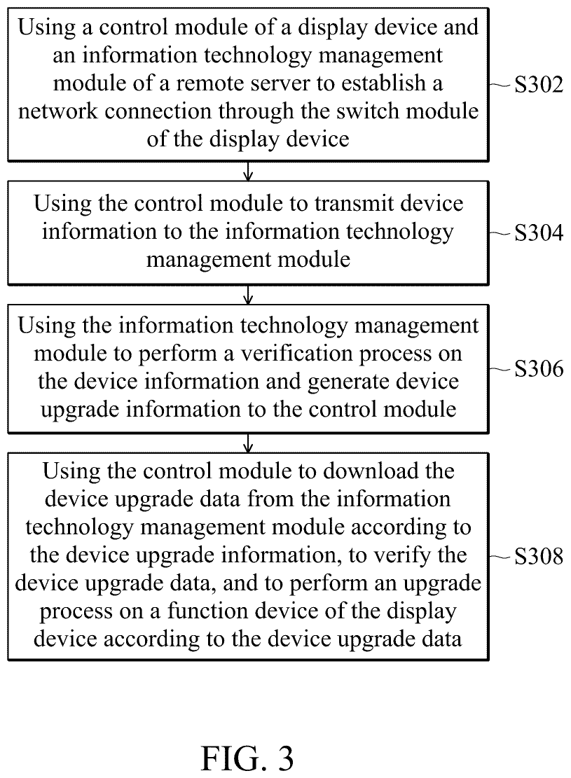

FIG. 3 is a flowchart of a device upgrade method according to an embodiment of the present invention. In step S302, the method involves using a control module of a display device and an information technology management module of a remote server to establish a network connection through the switch module of the display device. In step S304, the method involves using the control module to transmit device information to the information technology management module. In step S306, the method involves using the information technology management module to perform a verification process on the device information and generate device upgrade information to the control module. In an embodiment, after the information technology management module passes the verification process of the device information, the information technology management module may generate the device upgrade information to the control module. In step S308, the method involves using the control module to download the device upgrade data from the information technology management module according to the device upgrade information, to verify the device upgrade data, and to perform an upgrade process on a function device of the display device according to the device upgrade data.

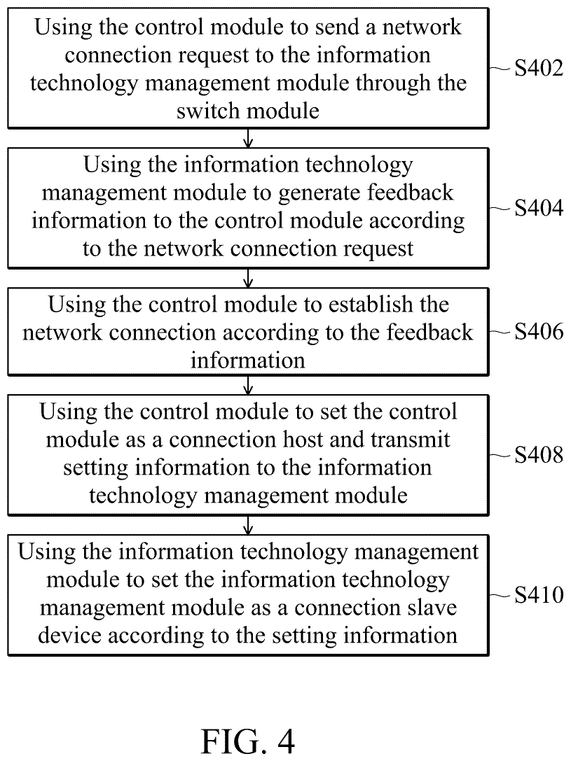

FIG. 4 is a detailed flowchart of step S302 in FIG. 3. In step S402, the method involves using the control module to send a network connection request to the information technology management module through the switch module. In step S404, the method involves using the information technology management module to generate feedback information to the control module according to the network connection request. In step S406, the method involves using the control module to establish the network connection according to the feedback information. In step S408, the method involves using the control module to set the control module as a connection host and transmit setting information to the information technology management module. In step S410, the method involves using the information technology management module to set the information technology management module as a connection slave device according to the setting information.

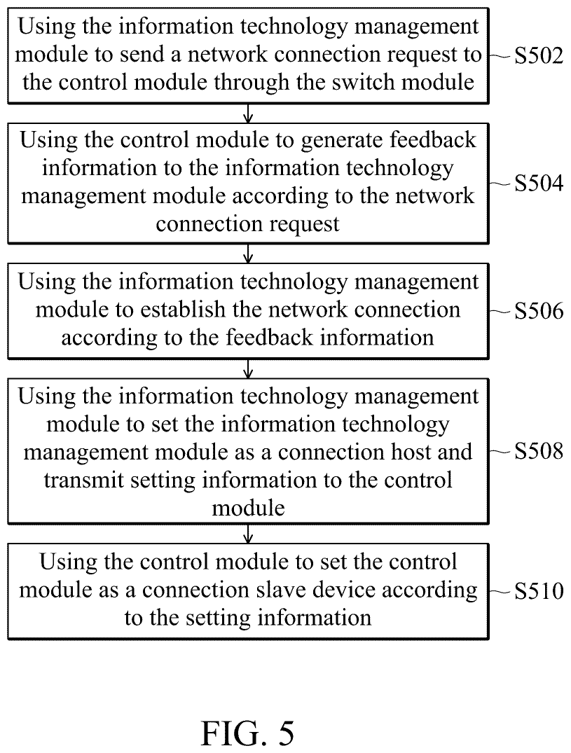

FIG. 5 is another detailed flowchart of step S302 in FIG. 3. In step S502, the method involves using the information technology management module to send a network connection request to the control module through the switch module. In step S504, the method involves using the control module to generate feedback information to the information technology management module according to the network connection request. In step S506, the method involves using the information technology management module to establish the network connection according to the feedback information. In step S508, the method involves using the information technology management module to set the information technology management module as a connection host and transmit setting information to the control module. In step S510, the method involves using the control module to set the control module as a connection slave device according to the setting information.

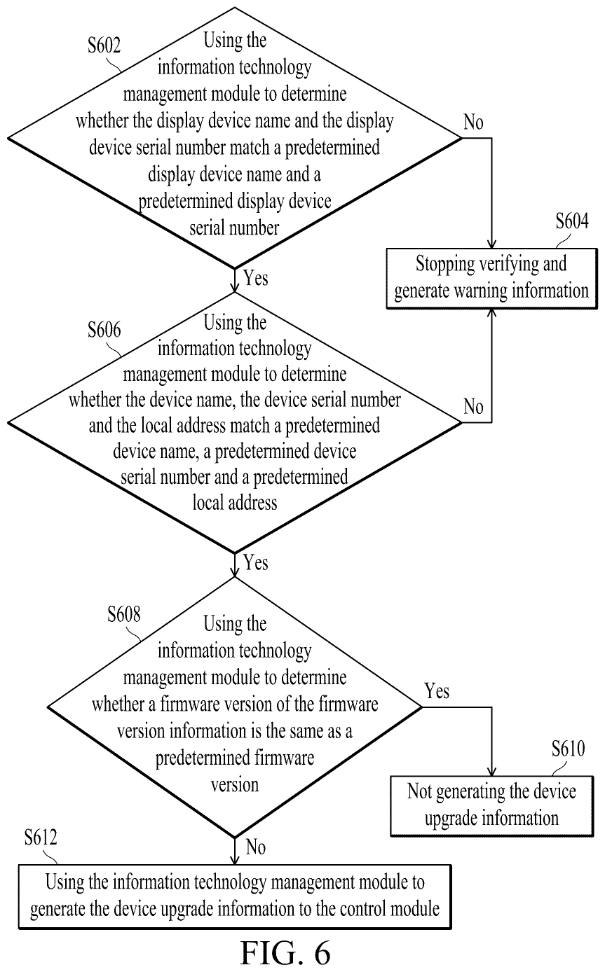

FIG. 6 is a detailed flowchart of step S306 in FIG. 3. In the embodiment, the device information includes, for example, a display device name and a display device serial number corresponding to the display device and a device name, a device serial number, a local address and firmware version information corresponding to the function device. In step S602, the method involves using the information technology management module to determine whether the display device name and the display device serial number match a predetermined display device name and a predetermined display device serial number. When determining that the display device name and the display device serial number do not match the predetermined display device name and the predetermined display device serial number, the method performs step S604. In step S604, the method involves stopping verifying and generate warning information.

When determining that the display device name and the display device serial number match the predetermined display device name and the predetermined display device serial number, in response to the display device name and the display device serial number matching the predetermined display device name and the predetermined display device serial number, the method performs step S606. In step S606, the method involves using the information technology management module to determine whether the device name, the device serial number and the local address match a predetermined device name, a predetermined device serial number and a predetermined local address. When determining that the device name, the device serial number and the local address do not match the predetermined device name, the predetermined device serial number and the predetermined local address, the method performs step S604. In step S604, the method involves stopping verifying and generate the warning information.

When determining that the device name, the device serial number and the local address match the predetermined device name, the predetermined device serial number and the predetermined local address, in response to the device name, the device serial number and the local address matching the predetermined device name, the predetermined device serial number and the predetermined local address, the method performs step S608. In step S608, the method involves using the information technology management module to determine whether a firmware version of the firmware version information is the same as a predetermined firmware version.

When determining that the firmware version is the same as the predetermined firmware version, the method performs S610. In step S610, the method involves not generating the device upgrade information. When determining that the firmware version is not the same as the predetermined firmware version, in response to the firmware version not being the same as the predetermined firmware version, the method performs step S612. In step S612, the method involves using the information technology management module to generate the device upgrade information to the control module.

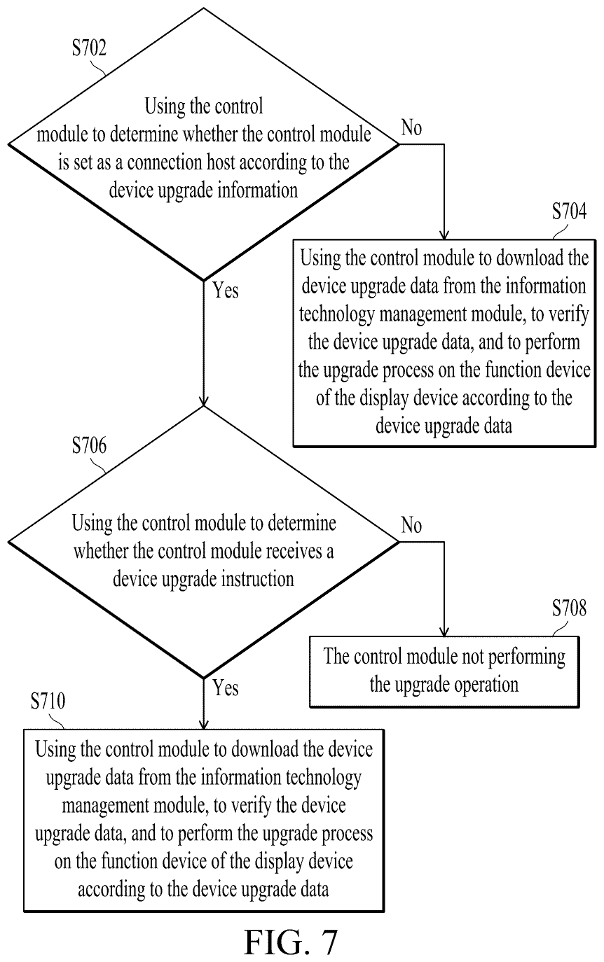

FIG. 7 is a detailed flowchart of step S308 in FIG. 3. In step S702, the method involves using the control module to determine whether the control module is set as a connection host according to the device upgrade information. When determining that the control module is not set as the connection host, in response to determining that the control module is not set as the connection host, the method performs step S704. In step S704, the method involves using the control module to download the device upgrade data from the information technology management module, to verify the device upgrade data, and to perform the upgrade process on the function device of the display device according to the device upgrade data. When determining that the control module is set as the connection host, in response to determining that the control module is set as the connection host, the method performs step S706, the method involves using the control module to determine whether the control module receives a device upgrade instruction.

When determining that the control module does not receive the device upgrade instruction, the method performs step S708. In step S708, the method involves the control module not performing the upgrade operation. When determining that the control module receives the device upgrade instruction, in response to determining that the control module receives the device upgrade instruction, the method performs step S710. In step S710, the method involves using the control module to download the device upgrade data from the information technology management module, to verify the device upgrade data, and to perform the upgrade process on the function device of the display device according to the device upgrade data.

In some embodiments, the device upgrade instruction includes, for example, an immediate upgrade instruction, a scheduled upgrade instruction or a non-upgrade instruction.

It should be noted that the order of the steps of FIG. 3, FIG. 4, FIG. 5, FIG. 6 and FIG. 7 is only for illustrative purposes, and is not intended to limit the order of the steps of the present invention. The user may change the order of the steps above to meet specific requirements. The flowcharts described above may add additional steps or use fewer steps without departing from the spirit and scope of the present invention.

In summary, according to the device upgrade method and the device upgrade system disclosed by the embodiment of the present invention, the control module of the display device and the information technology management module of the remote server establish the network connection through the switch module of the display device. The control module transmits device information to the information technology management module. The information technology management module performs the verification process on the device information and generates the device upgrade information to the control module. The control module downloads the device upgrade data from the information technology management module according to the device upgrade information, verifies the device upgrade data, and performs the upgrade process on the function device of the display device according to the device upgrade data. Therefore, it may effectively increase the efficiency of device upgrade, decrease the time cost and complexity of device upgrade, improve the user experience, improve the process of the device upgrade and maintenance and increase the convenience of use.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device upgrade method, comprising:
using a control module of a display device and an information technology management module of a remote server to establish a network connection through a switch module of the display device;
using the control module to transmit device information to the information technology management module;
using the information technology management module to perform a verification process on the device information and generate device upgrade information to the control module; and
using the control module to download the device upgrade data from the information technology management module according to the device upgrade information, to verify the device upgrade data, and to perform an upgrade process on a function device of the display device according to the device upgrade data.

2. The device upgrade method as claimed in claim 1, wherein the step of using the control module of the display device and the information technology management module of the remote server to establish the network connection through the switch module of the display device comprises:
using the control module to send a network connection request to the information technology management module through the switch module;
using the information technology management module to generate feedback information to the control module according to the network connection request; and
using the control module to establish the network connection according to the feedback information.

3. The device upgrade method as claimed in claim 2, wherein the step of using the control module of the display device and the information technology management module of the remote server to establish the network connection through the switch module of the display device further comprises:
using the control module to set the control module as a connection host and transmit setting information to the information technology management module; and
using the information technology management module to set the information technology management module as a connection slave device according to the setting information.

4. The device upgrade method as claimed in claim 1, wherein the step of using the control module of the display device and the information technology management module of the remote server to establish the network connection through the switch module of the display device comprises:
using the information technology management module to send a network connection request to the control module through the switch module;
using the control module to generate feedback information to the information technology management module according to the network connection request; and
using the information technology management module to establish the network connection according to the feedback information.

5. The device upgrade method as claimed in claim 4, wherein the step of using the control module of the display device and the information technology management module of the remote server to establish the network connection through the switch module of the display device further comprises:
using the information technology management module to set the information technology management module as a connection host and transmit setting information to the control module; and
using the control module to set the control module as a connection slave device according to the setting information.

6. The device upgrade method as claimed in claim 1, wherein the device information comprises a display device name and a display device serial number corresponding to the display device and a device name, a device serial number, a local address and firmware version information corresponding to the function device.

7. The device upgrade method as claimed in claim 1, wherein the step of using the information technology management module to perform the verification process on the device information and generate device upgrade information to the control module comprises:
using the information technology management module to determine whether the display device name and the display device serial number match a predetermined display device name and a predetermined display device serial number;
in response to the display device name and the display device serial number matching the predetermined display device name and the predetermined display device serial number, using the information technology management module to determine whether the device name, the device serial number and the local address match a predetermined device name, a predetermined device serial number and a predetermined local address;
in response to the device name, the device serial number and the local address matching the predetermined device name, the predetermined device serial number and the predetermined local address, using the information technology management module to determine whether a firmware version of the firmware version information is the same as a predetermined firmware version; and
in response to the firmware version not being the same as the predetermined firmware version, using the information technology management module to generate the device upgrade information to the control module.

8. The device upgrade method as claimed in claim 1, wherein the step of using the control module to download the device upgrade data from the information technology management module according to the device upgrade information, to verify the device upgrade data, and to perform the upgrade process on the function device of the display device according to the device upgrade data comprises:
using the control module to determine whether the control module is set as a connection host according to the device upgrade information;
in response to determining that the control module is not set as the connection host, using the control module to download the device upgrade data from the information technology management module, to verify the device upgrade data, and to perform the upgrade process on the function device of the display device according to the device upgrade data;
in response to determining that the control module is set as the connection host, using the control module to determine whether the control module receives a device upgrade instruction;
in response to determining that the control module receives the device upgrade instruction, using the control module to download the device upgrade data from the information technology management module, to verify the device upgrade data, and to perform the upgrade process on the function device of the display device according to the device upgrade data.

9. The device upgrade method as claimed in claim 8, wherein the device upgrade instruction comprises an immediate upgrade instruction, a scheduled upgrade instruction or a non-upgrade instruction.

10. A device upgrade system, comprising:
a remote server, comprising an information technology management module; and
a display device, comprising:
a function device;
a switch module, connected to the information technology management module;
a control module, connected to the switch module and the function device;
wherein the control module and the information technology management module are configured to establish a network connection through the switch module, the control module is configured to transmit device information to the information technology management module, the information technology management module is configured to perform a verification process on the device information and generate device upgrade information to the control module, the control module is configured to download the device upgrade data from the information technology management module according to the device upgrade information, to verify the device upgrade data, and to perform an upgrade process on the function device of the display device according to the device upgrade data.

11. The device upgrade system as claimed in claim 10, wherein the control module comprises:
a gateway module, configured to establish the network connection with the information technology management module through the switch module, transmit device information to the information technology management module, and download the device upgrade data from the information technology management module according to the device upgrade information;
a verification module, configured to verify the device upgrade data to generate a device upgrade notification;
a log module, configured to record the device upgrade notification; and
an upgrade module, configured to use the device upgrade data to perform the upgrade process on the function device according to the device upgrade notification.

12. The device upgrade system as claimed in claim 10, wherein the control module further comprises:
a storage module, configured to store the device upgrade data.

13. The device upgrade system as claimed in claim 10, wherein the control module is configured to send a network connection request to the information technology management module through the switch module, the information technology management module is configured to generate feedback information to the control module according to the network connection request, and the control module is configured to establish the network connection according to the feedback information.

14. The device upgrade system as claimed in claim 13, wherein the control module is configured to set the control module as a connection host and transmit setting information to the information technology management module, and the information technology management module is configured to set the information technology management module as a connection slave device according to the setting information.

15. The device upgrade system as claimed in claim 10, wherein the information technology management module is configured to send a network connection request to the control module through the switch module, the control module is configured to generate feedback information to the information technology management module according to the network connection request, and the information technology management module is configured to establish the network connection according to the feedback information.

16. The device upgrade system as claimed in claim 15, wherein the information technology management module is configured to set the information technology management module as a connection host and transmit setting information to the control module, and the control module is configured to set the control module as a connection slave device according to the setting information.

17. The device upgrade system as claimed in claim 10, wherein the device information comprises a display device name and a display device serial number corresponding to the display device and a device name, a device serial number, a local address and firmware version information corresponding to the function device.

18. The device upgrade system as claimed in claim 17, wherein the information technology management module is configured to determine whether the display device name and the display device serial number match a predetermined display device name and a predetermined display device serial number, in response to the display device name and the display device serial number matching the predetermined display device name and the predetermined display device serial number, the information technology management module is configured to determine whether the device name, the device serial number and the local address match a predetermined device name, a predetermined device serial number and a predetermined local address, in response to the device name, the device serial number and the local address matching the predetermined device name, the predetermined device serial number and the predetermined local address, the information technology management module is configured to determine whether a firmware version of the firmware version information is the same as a predetermined firmware version, and in response to the firmware version not being the same as the predetermined firmware version, the information technology management module is configured to generate the device upgrade information to the control module.

19. The device upgrade system as claimed in claim 10, wherein the control module is configured to determine whether the control module is set as a connection host according to the device upgrade information, in response to determining that the control module is not set as the connection host, the control module is configured to download the device upgrade data from the information technology management module, to verify the device upgrade data, and to perform the upgrade process on the function device of the display device according to the device upgrade data, in response to determining that the control module is set as the connection host, the control module is configured to determine whether the control module receives a device upgrade instruction, and in response to determining that the control module receives the device upgrade instruction, the control module is configured to download the device upgrade data from the information technology management module, to verify the device upgrade data, and to perform the upgrade process on the function device of the display device according to the device upgrade data.

20. The device upgrade system as claimed in claim 19, wherein the device upgrade instruction comprises an immediate upgrade instruction, a scheduled upgrade instruction or a non-upgrade instruction.
